(19) United States
(12) Patent Application Publication
(10) Pub. No.: US 2013/0093373 A1
(43) Pub. Date: Apr. 18, 2013

(54) Motor Driving Circuit and Correction Method

(71) Applicants: Kun-Min Chen, Changhua County (TW); Ming-Jung Tsai, Hsinchu City (TW); Ching-Sheng Li, Hsinchu County (TW)

(72) Inventors: Kun-Min Chen, Changhua County (TW); Ming-Jung Tsai, Hsinchu City (TW); Ching-Sheng Li, Hsinchu County (TW)

(21) Appl. No.: 13/300,645

(22) Filed: Nov. 20, 2011

(30) Foreign Application Priority Data
Oct. 13, 2011 (TW) 100137102

(51) Int. Cl. H02H 7/122

(52) U.S. Cl. 318/400.21

(57) ABSTRACT

The present invention discloses a motor driving circuit for driving a motor, including an electrostatic discharge diode, having an input port and an output port coupled to a first DC power supply, a pulse width modulation source coupled to the input port of the electrostatic discharge diode to generate a pulse width modulation signal, and a driving module including a voltage detecting module comparing the pulse width modulation signal with a voltage of the output port of the electrostatic discharge diode to generate a voltage comparison result, a lock/restart module generating a shut-down signal according to the voltage comparison result, a control module generating a control signal according to the shut-down signal, and a bridge circuit switching the motor on or off by turning on or turning off an up-bridge circuit and a down-bridge circuit according to the control signal.

### BACKGROUND OF THE INVENTION

1. Field of the Invention

The present invention relates to a motor driving circuit and its related correction method, and more particularly, to a motor driving circuit and its related correction method in which an electrostatic discharge diode is additionally disposed.

2. Description of the Prior Art

A motor is an electronic device for transferring electrical energy into dynamic energy, for example a DC motor, an AC motor or a stepper motor, etc., wherein the DC motor or the AC motor is frequently utilized in non-sophisticated control devices, such as a fan. Generally, the DC motor rotates based on a current direction or a current passing through coils of a rotor of the DC motor to generate different amounts or polarized direction of magnetic force, so as to attract or repel a permanent magnet on a stator of the DC motor to make the motor rotate.

Please refer to FIG. 1, which illustrates a schematic diagram of a motor driving circuit 10 of the prior art. The motor driving circuit 10 is utilized for controlling a motor 12, and includes a DC power supply 100, a control module 102, a pulse width modulation source 104, a Hall sensor 106 and a bridge circuit 108. The bridge circuit 108 includes four switches MP1, MP2, MN1 and MN2, and the switches MP1 and MP2 form an up-bridge circuit and the switches MN1 and MN2 form a down-bridge circuit. The motor driving circuit 10 uses a technique called pulse width modulation (PWM), which adjusts a period of the DC power supply 100 to transfer energy to a load, i.e. the motor 12. The period of transferring energy to the load versus a square wave period form a ratio called duty cycle. When the duty cycle equals 1, the DC power supply 100 transfers nearly full energy to the load; otherwise, when the duty cycle equals 0, the DC power supply 100 barely transfers any energy to the load. The Hall sensor 106 generates a sensing result for indicating a current direction passing through the motor 12 and a position and a rotating speed of the stator of the motor 12. Therefore, the motor 12 can include one or a plurality of Hall sensors 16 to make the control module 102 correctly turn the up-bridge circuit or the down-bridge circuit of the bridge circuit 108 on or off, so as to control the rotation of the motor 12, wherein the motor 12 is coupled between two output ports OUT1 and OUT2 of the bridge circuit 108.

The control module 12 receives a pulse width modulation signal of the pulse width modulation source 104 and a sensing result of the Hall sensor 106 to generate four control signals for turning switches MP1, MP2, MN1 and MN2 on or off, respectively. According to the Hall sensor 106 which detects the position of the stator, the control module 102 supplies energy to the motor 12 in two motor-driving modes of the motor 12, i.e. a first motor-driving mode and a second motor-driving mode. In the first motor-driving mode, the control module 102 turns on the switches MP1 and MN2 and turns off the switches MP2 and MN1, and the current passes through the DC power supply 100, the switches MP1, the output port OUT1, the motor 12, the output port OUT2, the switches MN2 and the ground GND, so as to transfer energy to the motor 12. In the second motor-driving mode, the control module 102 turns on the switches MP2 and MN1 and turns off the switches MP1 and MN2, and the current passes through the DC power supply 100, the switch MP2, the output port OUT2, the motor 12, the output port OUT1, the switch MN1 and the ground GND, so as to transfer energy to the motor 12. As a result, the motor 12 switches periodically between the first motor-driving mode and the second motor-driving mode to rotate normally, and the control module 102 cooperates with the duty cycle of the pulse width modulation source 104 to adjust energy transferred to the motor 12, which can save electrical energy as well as control rotation speed.

However, during the process of packaging, test, transport and manipulation, the electrostatic discharge effect can conduct external electricity in an inappropriate manner to cause damage to internal circuits of the motor driving circuit. Therefore, how to alleviate the electrostatic discharge effect in the motor driving circuit has become an important issue in the art.

### SUMMARY OF THE INVENTION

It is therefore an objective of the present invention to provide a motor driving circuit and its related correction method for driving a motor.

A motor driving circuit for driving a motor, including an electrostatic discharge diode, having an input port and an output port coupled to a first DC power supply, a pulse width modulation source coupled to the input port of the electrostatic discharge diode to generate a pulse width modulation signal, and a driving module including a voltage detecting module comparing the pulse width modulation signal with a voltage of the output port of the electrostatic discharge diode to generate a voltage comparison result, a lock/restart module generating a shut-down signal according to the voltage comparison result, a control module generating a control signal according to the shut-down signal, and a bridge circuit switching the motor on or off by turning on or turning off an up-bridge circuit and a down-bridge circuit according to the control signal.

A correction method for driving a motor, the correction method comprising comparing a pulse width modulation signal with a voltage of an output port of an electrostatic discharge diode to generate a voltage comparison result; generating a shut-down signal according to the voltage comparison result; generating a control signal according to the shut-down signal; and switching the motor on or off by turning on or turning off an up-bridge circuit and a down-bridge circuit according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a motor driving circuit of the prior art.

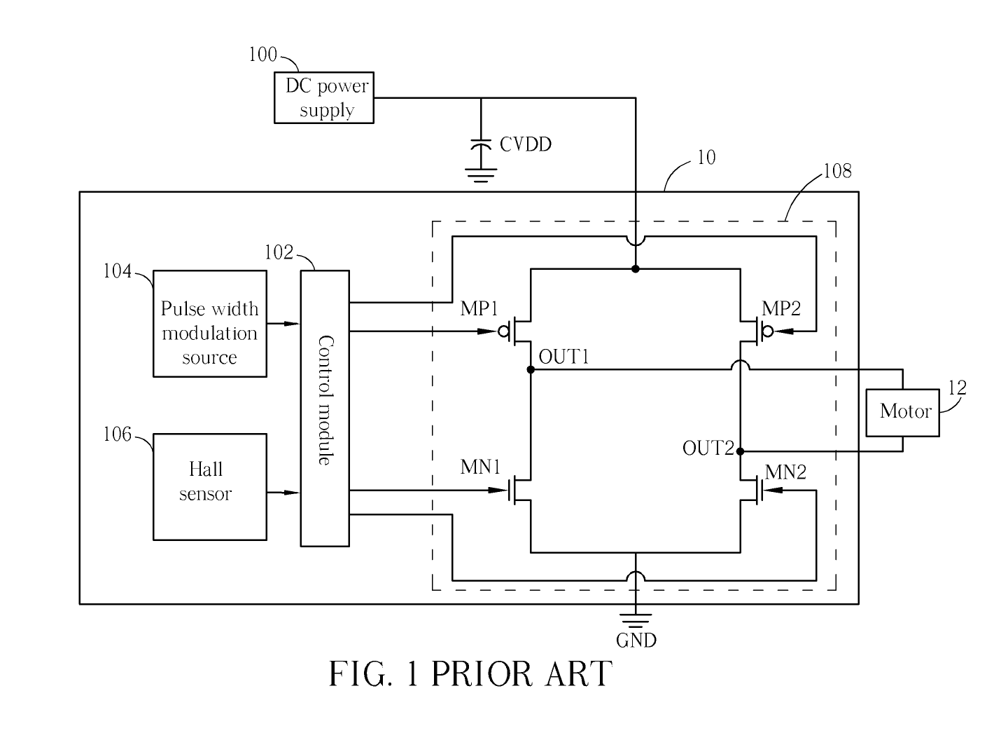

FIG. 2 illustrates a schematic diagram of a motor driving circuit.

FIG. 3A illustrates a timing diagram of related signals of the motor driving circuit while the motor rotates.

FIG. 3B illustrates a timing diagram of related signals of the motor driving circuit while the motor operates at different modes

FIG. 4 illustrates a timing diagram of related signals of the motor driving circuit, which is disposed one electrostatic discharge diode and incorrectly enters into the lock mode.

FIG. 5 illustrates a schematic diagram of the motor driving circuit.

FIG. 6 illustrates a timing diagram of related signals of the motor driving circuit.

FIG. 7 illustrates a flow chat of a correction process of the present invention.

FIG. 8 illustrates a flow chat of a motor driving process of the present invention.

### DETAILED DESCRIPTION

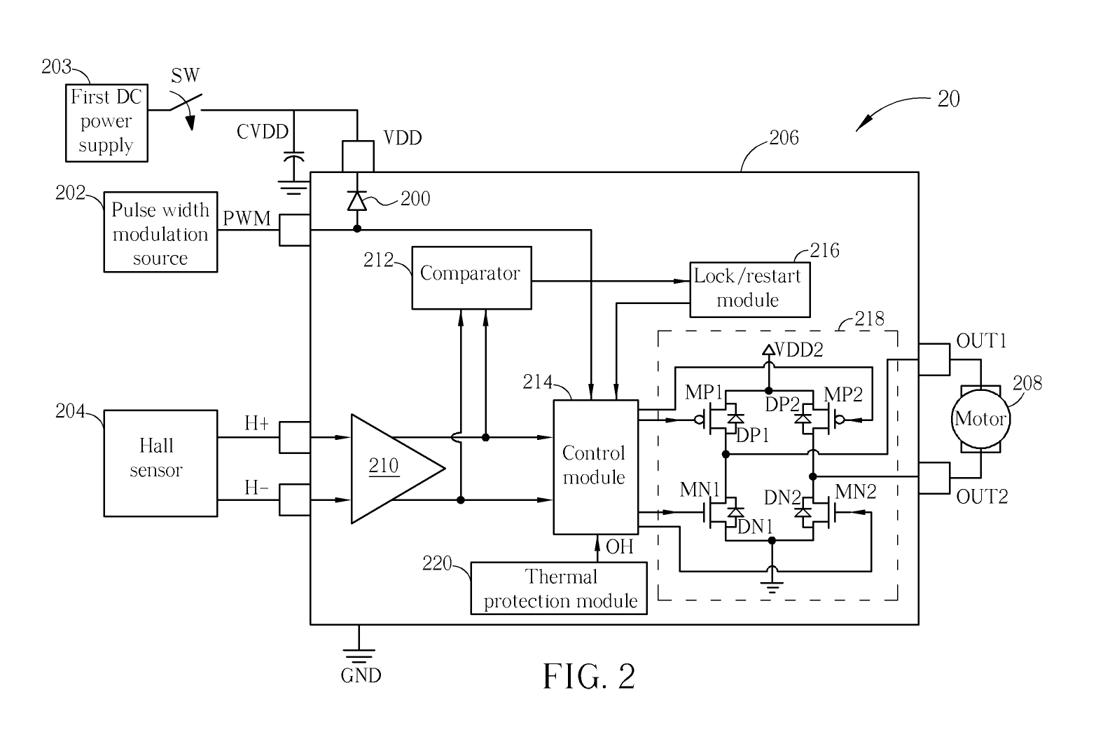

Please refer to FIG. 2, which illustrates a schematic diagram of a motor driving circuit 20. To alleviate the electrostatic discharge effect which damages the motor driving circuit 20, the motor driving circuit 20 disposes an electrostatic discharge diode 200 between a pulse width modulation source 200 and a first DC power supply 203 to protect motor driving circuit 20 in the process of packaging, test, transport and manipulation from the electrostatic discharge effect, which conducts electricity in an inappropriate manner to cause damage to internal circuits of the motor driving circuit. At the same time, position of the electrostatic discharge diode 200 can effectively reduce another electrostatic discharge effect generated by the pulse width modulation source 202.

The motor driving circuit 20 further includes a Hall sensor 204 and a driving module 206 for driving a motor 208. The driving module 206 further includes an operational amplifier 210, a comparator 212, a control module 214, a lock/restart module 216, a bridge circuit 218 and a thermal protection module 220. Furthermore, a switch SW is coupled to the first DC power supply 203 for conducting the first DC power supply 203 to an output port of the electrostatic discharge diode 200. A bypass capacitor CVDD is also coupled to the switch SW to stabilize an output voltage VDD of the first DC power supply 203. The pulse width modulation source 202 is coupled to an input port of the electrostatic discharge diode 200. The bridge circuit 218 includes switches MP1, MP2, MN1 and MN2 and diodes DP1, DP2, DN1 and DN2. In this embodiment, the switches MP1 and MP2 are realized by p-type MOS transistors to form the up-bridge circuit, switches MN1 and MN2 are realized by n-type MOS transistors to form the down-bridge circuit, and the diodes DP1, DP2, DN1 and DN2 are sequentially coupled between output ports and input ports of the switches MP1, MP2, MN1 and MN2.

In detail, the Hall sensor 204 is utilized to sense a current direction of the motor 208 for generating a sensing result to output to the operational amplifier 210. The operational amplifier 210 outputs an amplified signal to the control module 214 and the comparator 212 according to the sensing result. The comparator 212 outputs a Hall comparison signal HRST to the lock/restart module 216 according to the amplified signal. The lock/restart module 216 outputs a shut-down signal SD to the control module 214 according to the Hall comparison signal HRST. The thermal protection module 214 also outputs an over-heat signal OH to the control module 214. Therefore, the control module 214 outputs control signals to switch the switches MP1, MP2, MN1 and MN2 on or off according to the amplified signal, the shut-down signal SD, the pulse width modulation signal and the over-heat signal OH. The motor 208 is coupled between two output ports OUT1 and OUT2 of the bridge circuit 218. Based on the on or off states of the switches MP1, MP2, MN1 and MN2, the motor 208 is accordingly turned on or off. Furthermore, the switches MP1 and MP2 are realized by p-type MOS transistors, wherein sources of the switches MP1 and MP2 are coupled to a second DC power supply VDD2, and gates of the switches MP1 and MP2 are coupled to the control module 214 to receive control signals for the basis of turning the switches MP1 and MP2 on or off. The switches MN1 and MN2 are realized by n-type MOS transistors, wherein sources of the switches MN1 and MN2 are coupled to the ground GND, gates of the switches MN1 and MN2 are coupled to the control module 214 to receive control signals for the basis of turning the switches MN1 and MN2 on or off, and drains of the switches MP1 and MP2 as well as drains of the switches MN1 and MN2 are coupled to each other. More particularly, the output port OUT1 is coupled to the drains of the switches MP1 and MN1, and the output port OUT2 is coupled to the drains of the switches MP2 and MN2. The diodes DP1, DP2, DN1 and DN2 are sequentially coupled to the switches MP1, MP2, MN1 and MN2 to provide another conducting path for the current in the bridge circuit 218, to provide charging or discharging operation of the motor 208.

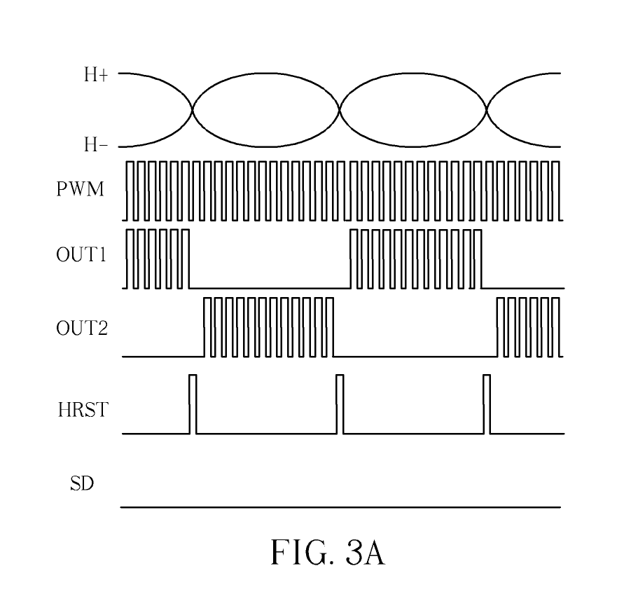

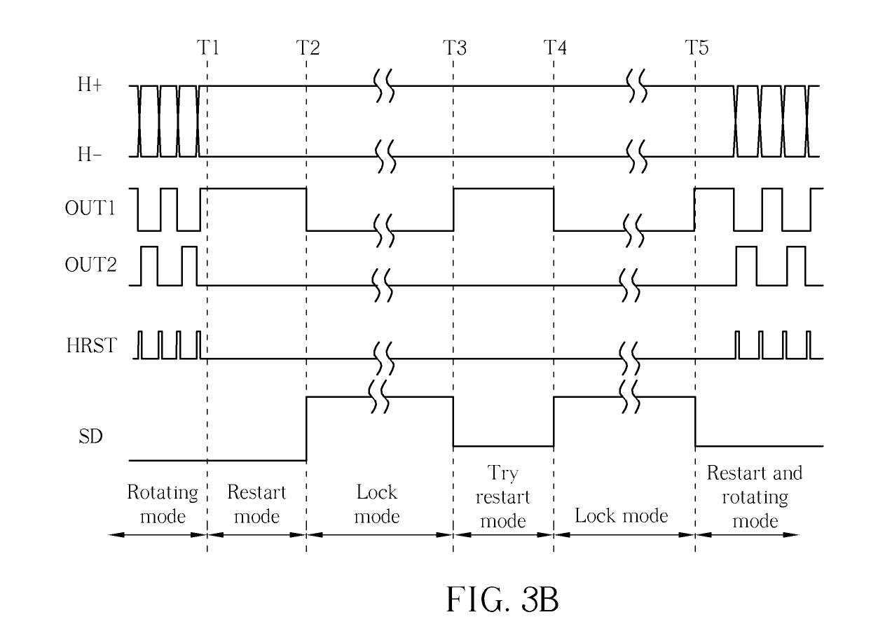

Please refer to FIG. 3A, which illustrates a timing diagram of related signals of the motor driving circuit 20 while the motor 208 rotates. Generally, when the motor 208 rotates, the Hall sensor 204 first determines the current direction passing through the motor 208 to provide two periodical sinusoidal signals H+ and H− to the driving module 206. The pulse width modulation source 202 outputs periodical square signal PWM to provide the basis for conduction of the switches MP1, MP2, MN1 and MN2. Accordingly, the motor 208 outputs the same signal as the periodical square signal PWM at two output ports OUT1 and OUT2 when the motor 208 is operating in the two driving modes. If the Hall sensor 204 senses a change of the current direction of the motor 208, i.e. intersection of the sinusoidal signals H+ and H−, the comparator 212 outputs the Hall comparison signal HRST to the lock/restart module 216 to reset the lock/restart module 216 in order not to output a shut-down signal SD to the control module 214, i.e. the shut-down signal SD keeps a low state. Under these circumstances, the bridge circuit 218 operates with normal function in both the two driving modes, and the motor 208 continuously rotates to output the periodical square signal at the output ports OUT1 and OUT2.

Please refer to FIG. 3B, which illustrates a timing diagram of related signals of the motor driving circuit 20 while the motor 208 operates at different modes. When the motor 208 operates at a rotating mode, i.e. before the timing T1, the related signals can be referred from the timing diagram as shown in FIG. 3A, which is not described hereinafter. When the motor 208 enters into a restart mode, i.e. from the timing T1 to T2, the Hall sensor 204 determines that there is no change of current direction, and the signal H+ remains a high state and the signal H− remains a low state. Since the motor 208 can be viewed equivalently as an inductor, the output port OUT1 remains a high state and the output port OUT2 remains a low state, which generates a voltage difference between the output ports OUT1 and OUT2 to form a current passing through the motor 208 based on Ohm's Law, and accordingly generate heat. The corresponding Hall comparison signal HRST and the shut-down signal SD remain low state. In order to prevent the motor 208 from the possibility of burning down due to the heat, the lock/restart module 216 can be realized as a counter. After a fixed period, such as one second, if the lock/restart module 216 has not yet received the Hall comparison signal HRST from the comparator 212, the lock/restart module 216 will output the shut-down signal SD to the control module 214 to turn off up-bridge circuit and down-bridge circuit of the bridge circuit 218, which makes the motor 208 discharge to reduce the heat. At this moment, the motor 208 will enter a lock mode, i.e. from the timing T2 to T3, and the output ports OUT1 and OUT2 remain low state. After the lock mode continues for a period, such as 5 to 10 seconds, the motor 208 will enter into a restart mode, i.e. from the timing T3 to T4, and try to rotate again. The corresponding output port OUT1 pulls up to a high state, and the shut-down signal SD pulls down to a low state. The motor 208 will repeat the restart mode and the lock mode several times, i.e. after the timing T5, and will reenter the rotating mode after the restart mode to make the motor 208 rotate again.

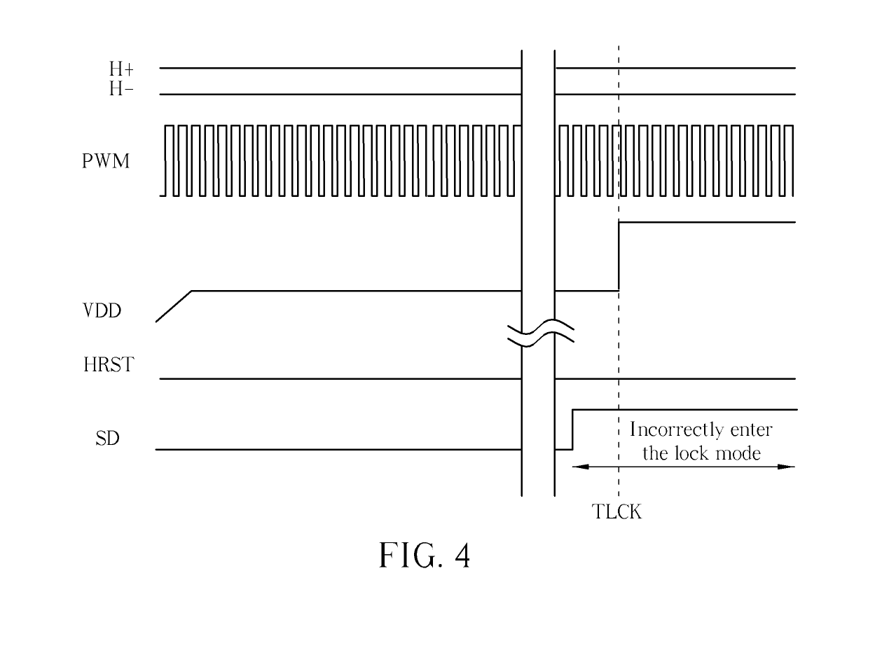

However, if the first DC power supply 203 and the pulse width modulation source 202 supply the driving module 206 at different timings, the motor 208 disposed with one electrostatic discharge diode 200 will incorrectly enter the lock mode. Please refer to FIG. 4, which illustrates a timing diagram of related signals of the motor driving circuit 20, which is disposed with one electrostatic discharge diode 200 and incorrectly enters into the lock mode. First, the pulse width modulation source 202 has inputted the periodical square signal PWM, and the switch SW is also ready to conduct the output voltage VDD outputted from the first DC power supply 203 to the driving module 206. Generally, the driving module 206 needs a smaller driving voltage in comparison with the motor 208. For example, the driving module 206 needs 1.5 Volts driving voltage, and the motor 208 needs 5 Volts driving voltage. Therefore, as input voltage outputted from the first DC power supply 203 increases from zero, the driving module 206 is driven first and the motor 208 does not rotate yet. The output ports OUT1 and OUT2 remain low state and the corresponding sinusoidal signals H+ and H− also remain low state. Under these circumstances, the comparator 212 will not output the Hall comparison signal HRST, and the lock/restart module 216 outputs the shut-down signal SD after a fixed period to the control module 214 to turn off the up-bridge circuit and the down-bridge circuit, which causes incorrect determination that the motor 208 has entered the lock mode, i.e. after the timing TLCK. In the lock mode, although the output voltage VDD of the first DC power supply 203 has already been utilized to drive the motor 208, the shut-down signal SD still remains high state to lead the control module 214 to continuously turn off the up-bridge circuit and the down-bridge circuit of the bridge circuit, and the motor 208 does not turn.

Noticeably, although the motor driving circuit 20 can effectively alleviate the electrostatic discharge effect of the pulse width modulation source 202 through the electrostatic discharge diode 200, the first DC power supply 203 and the pulse width modulation source 202 cause the motor 208 to enter into the lock mode incorrectly when they supply the driving module 206 at different timings. Therefore, the motor 208 will not turn for a while after motor driving circuit 20 starts, and a fan coupled to the motor 208 will not turn either, which reduces usability of the motor 208 with different driving sources.

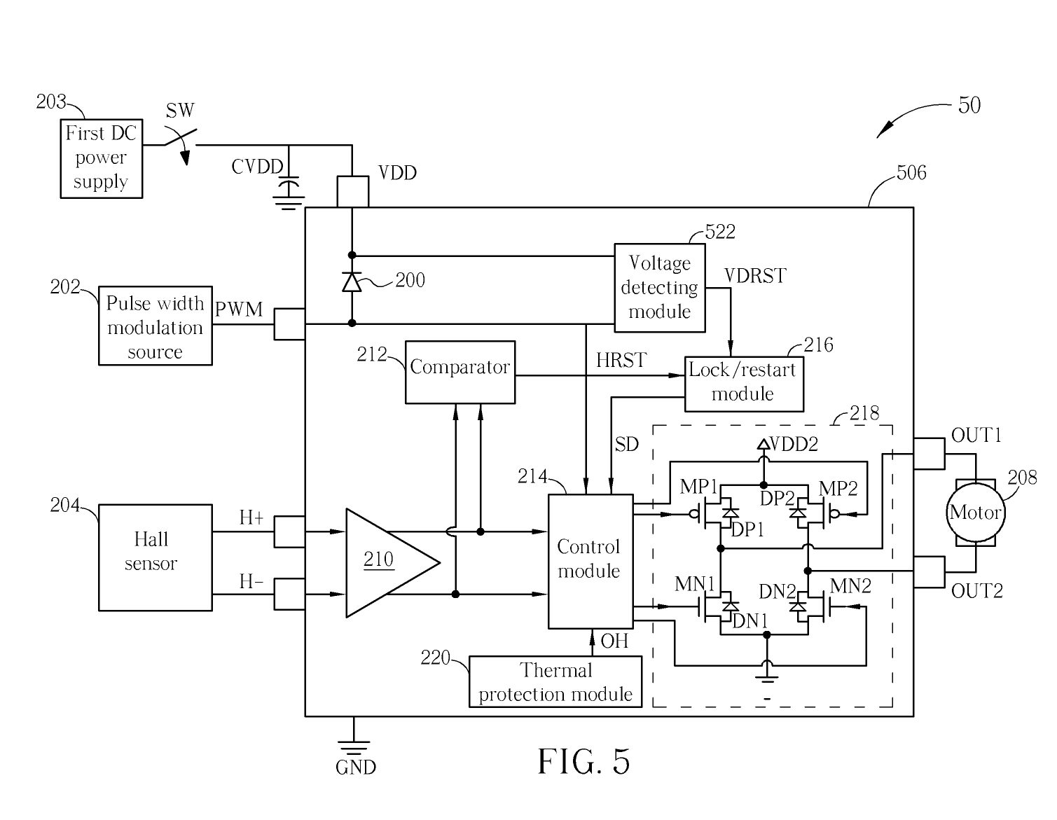

Therefore, the present invention further provides a solution for the motor driving circuit and its related method when the motor incorrectly enters into the lock mode. Please refer to FIG. 5, which illustrates a schematic diagram of the motor driving circuit 50. In comparison with FIG. 2, the motor driving circuit 50 as shown in FIG. 5 further includes a voltage detecting module 522 inside the driving module 506. Other elements shown in FIG. 5 maintain the same symbols as shown in FIG. 2 due to their similar connection relationships and technical characteristics, which are not described hereinafter for simplicity. As shown in FIG. 5, the voltage detecting module 522 is coupled between the input port and the output port of the electrostatic discharge diode 200, which are correspondingly coupled to the pulse width modulation source 202 and the first DC power supply 203 to detect a voltage difference between the input port and the output port of the electrostatic discharge diode 200. In other words, the voltage detecting module 522 compares the output voltage difference between the pulse width modulation source 202 and the output port of the electrostatic discharge diode 200. According to different requirements of users, a comparison default value can be preset in the voltage detecting module 522, such as a 0.2 Volts voltage value. When the voltage difference between the pulse width modulation source 202 and the output port of the electrostatic discharge diode 200 is larger than the comparison default value, the voltage detecting module 522 outputs a voltage comparison result VDRST to the lock/restart module 216 to prevent the lock/restart module 216 from outputting the shut-down signal SD to the control module 214, so as to turn off the up-bridge circuit and the down-bridge circuit. The voltage detecting module 522 provides another determination for the control module 214, at the same time, to cooperate with the amplified signal, the shut-down signal SD, the pulse width modulation signal and the over-heat signal OH, as shown in FIG. 2. All the mentioned signals are provided for the control module 214 to determine when to turn the up-bridge circuit and the down-bridge circuit on or off, so as to drive the motor 208 normally.

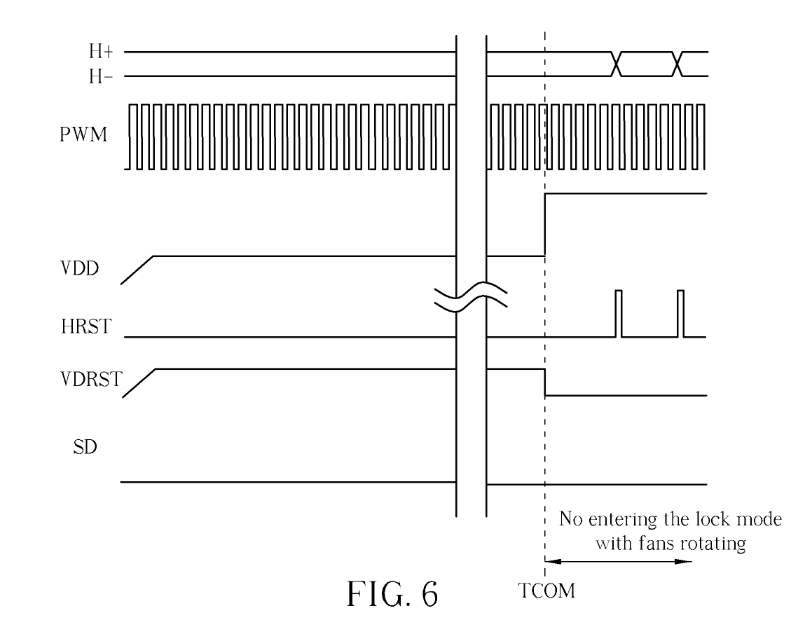

Please refer to FIG. 6, which illustrates a timing diagram of related signals of the motor driving circuit 50. Since the motor 208 has not rotated yet, the Hall sensor 204 determines the motor 208 has no change of current direction, and the outputted signal H+ remains high state and the outputted signal H− remains low state. The pulse width modulation source 202 first provides the periodical square signal PWM to the driving module 206. The first DC power supply 203 increases the output voltage VDD from zero after the switch SW conducts, and maintains a low conducting value at the timing TCOM to provide to the driving module 206. When the voltage difference between the pulse width modulation source 202 and the output port of the electrostatic discharge diode 200 is larger than the comparison default value, the voltage detecting module 522 pulls up the voltage comparison result VDRST to high state, and the shut-down signal SD will remain low state after the motor driving circuit 50 initiates, which will prevent the motor 208 from entering the lock mode. Until the output voltage VDD outputted from the first DC power supply 203 increases to the voltage level which can drive the motor 208, i.e. after the timing TCOM, the voltage comparison result VDRST pulls down to low state again. At this moment, the motor 208 is ready to enter the rotation mode, and the following details of the related signals can be referred from the previous description, which are not described hereinafter.

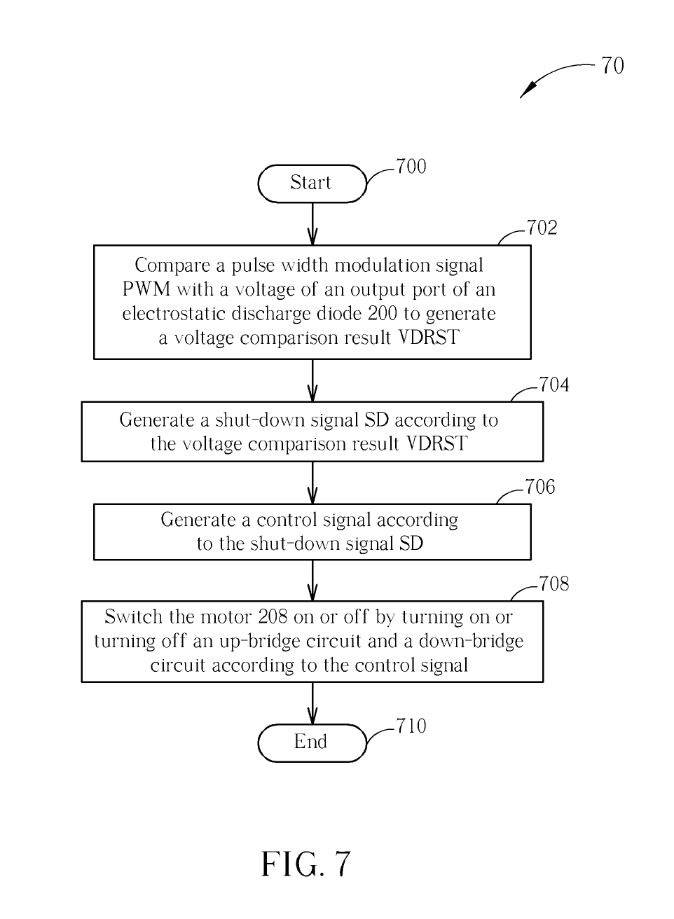

A correction method utilized with the motor driving circuit 50 of the present invention can be summarized in a correction process 70, as shown in FIG. 7. The correction process 70 comprises the following steps:

Step 700: Start.

Step 702: Compare a pulse width modulation signal PWM with a voltage of an output port of an electrostatic discharge diode 200 to generate a voltage comparison result VDRST.

Step 704: Generate a shut-down signal SD according to the voltage comparison result VDRST.

Step 706: Generate a control signal according to the shut-down signal SD.

Step 708: Switch the motor 208 on or off by turning on or turning off an up-bridge circuit and a down-bridge circuit according to the control signal.

Step 710: End.

Details of the correction process 70 can be fully understood by the motor driving circuit 50 shown in FIG. 5 as well as the timing diagram of the related signals shown in FIG. 6, which are not described hereinafter.

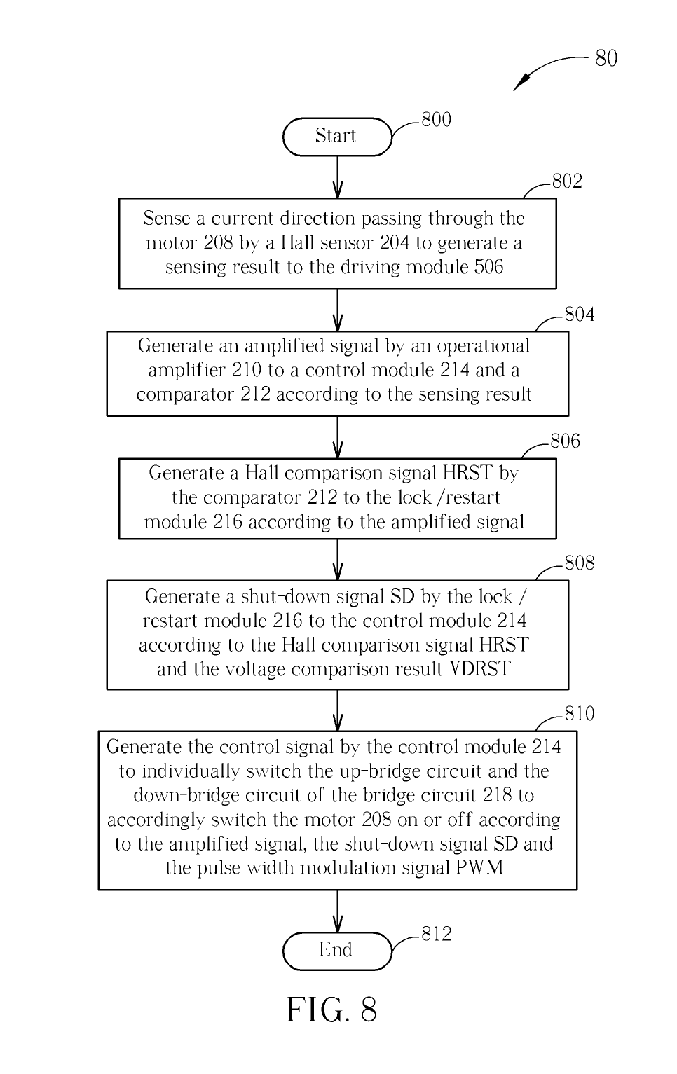

Furthermore, a motor driving method utilized with the motor driving circuit 50 of the present invention can be summarized into a motor driving process 80, as shown in FIG. 8. The motor driving process 80 comprises the following steps:

Step 800: Start.

Step 802: Sense a current direction passing through the motor 208 by a Hall sensor 204 to generate a sensing result to the driving module 506.

Step 804: Generate an amplified signal by an operational amplifier 210 to a control module 214 and a comparator 212 according to the sensing result.

Step 806: Generate a Hall comparison signal HRST by the comparator 212 to the lock/restart module 216 according to the amplified signal.

Step 808: Generate a shut-down signal SD by the lock/restart module 216 to the control module 214 according to the Hall comparison signal HRST and the voltage comparison result VDRST.

Step 810: Generate the control signal by the control module 214 to individually switch the up-bridge circuit and the down-bridge circuit of the bridge circuit 218 to accordingly switch the motor 208 on or off according to the amplified signal, the shut-down signal SD and the pulse width modulation signal PWM.

Step 812: End.

Details of the motor driving process 80 can be fully understood by the timing diagram of the related signals of the motor driving circuit 20 while the motor 208 rotates as shown in FIG. 3A, the timing diagram of the related signals of the motor driving circuit 20 in different modes of the motor 208 shown in FIG. 3B, the motor driving circuit 50 shown in FIG. 5 and the timing diagram of the related signals shown in FIG. 6, which are not further described hereinafter.

In the motor driving circuit and its related correction method of the present invention, the voltage detecting module is utilized for comparing the voltage difference between the input port and the output port of the electrostatic discharge diode to prevent the motor from incorrectly entering the lock mode as the motor just initiates, so as to make the motor rotate correctly. Therefore, those skilled in the art can adjust and modify the present invention according to practical requirements by other similar methods or applications to detect/compare the voltage difference between the input port and the output port of the electrostatic discharge diode, so as to achieve the similar purpose of the present invention, which is also within the scope of the present invention.

In summary, the present invention provides a motor driving circuit including an electrostatic discharge diode therein and a related correction method, which additionally include a voltage detecting module for comparing the voltage difference between a pulse width modulation source and an output port of the electrostatic discharge diode, so as to prevent a motor from incorrectly entering the lock mode. This ensures that the motor rotates normally after starting, and also effectively reduces the electrostatic discharge effect generated by the pulse width modulation source, so as to provide a better circuit design for protecting the motor driving circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor driving circuit for driving a motor, the motor driving circuit comprising:
an electrostatic discharge diode having an input port and an output port coupled to a first DC power supply;
a pulse width modulation source coupled to the input port of the electrostatic discharge diode to generate a pulse width modulation signal; and
a driving module comprising:
a voltage detecting module comparing the pulse width modulation signal with a voltage of the output port of the electrostatic discharge diode to generate a voltage comparison result;
a lock/restart module generating a shut-down signal according to the voltage comparison result;
a control module generating a control signal according to the shut-down signal; and
a bridge circuit switching the motor on or off by turning on or turning off an up-bridge circuit and a down-bridge circuit according to the control signal.

2. The motor driving circuit of claim 1, further comprising a Hall sensor for sensing a current direction passing through the motor to generate a sensing result to the driving module.

3. The motor driving circuit of claim 2, wherein the driving module further comprises:
an operational amplifier for generating an amplified signal to the control module and a comparator according to the sensing result.

4. The motor driving circuit of claim 3, wherein the comparator generates a Hall comparison signal to the lock/restart module according to the amplified signal.

5. The motor driving circuit of claim 4, wherein the lock/restart module outputs the shut-down signal to the control module according to the Hall comparison signal and the voltage comparison result.

6. The motor driving circuit of claim 5, wherein the control module generates the control signal to output to the bridge circuit according to the amplified signal, the shut-down signal and the pulse width modulation signal.

7. The motor driving circuit of claim 6, wherein the bridge circuit individually switches the up-bridge circuit and the down-bridge circuit to switch the motor on or off according to the control signal.

8. The motor driving circuit of claim 7, wherein the driving module further comprises a thermal protection module to output an over-heat signal to the control module, so as to generate the control signal to switch the bridge circuit on or off.

9. The motor driving circuit of claim 1, wherein the up-bridge circuit of the bridge circuit comprises an input port coupled to a second DC power supply, an output port, and a controlled port for connecting a voltage source received by the input port with the output port according to the control signal outputted from the control module; and the down-bridge circuit of the bridge circuit comprises an input port coupled to the output port of the up-bridge circuit, an output port coupled to the ground, and a controlled port for connecting a voltage source received by the input port with the output port according to the control signal outputted from the control module; wherein the motor is coupled between the output port of the up-bridge circuit and the output port of the down-bridge circuit.

10. The motor driving circuit of claim 1, further comprising:
a switch coupled between the first DC power supply and a capacitor to connect the first DC power supply with the electrostatic discharge diode.

11. A correction method for driving a motor, the correction method comprising:
comparing a pulse width modulation signal with a voltage of an output port of an electrostatic discharge diode to generate a voltage comparison result;
generating a shut-down signal according to the voltage comparison result;
generating a control signal according to the shut-down signal; and
switching the motor on or off by turning on or turning off an up-bridge circuit and a down-bridge circuit according to the control signal.

12. The correction method of claim 11, wherein if the voltage comparison result is that the pulse width modulation signal is larger than a voltage of the output port of the electrostatic discharge diode, the voltage comparison result is outputted to a lock/restart module.

13. The correction method of claim 12, wherein the lock/restart module outputs the shut-down signal to a control module.

14. The correction method of claim 13, wherein the control module generates the control signal to individually switch the up-bridge circuit and the down-bridge circuit to switch the motor on or off.

15. The correction method of claim 11, further comprising:
sensing a current direction passing through the motor by a Hall sensor to generate a sensing result to the driving module;
generating an amplified signal by an operational amplifier to a control module and a comparator according to the sensing result;
generating a Hall comparison signal by the comparator to the lock/restart module according to the amplified signal;
generating the shut-down signal by the lock/restart module to the control module according to the Hall comparison signal and the voltage comparison result; and
generating the control signal by the control module to individually switch the up-bridge circuit and the down-bridge circuit of the bridge circuit to accordingly switch the motor on or off according to the amplified signal, the shut-down signal and the pulse width modulation signal.

16. The correction method of claim 15, wherein the driving module further comprises a thermal protection module to output an over-heat signal to the control module, so as to generate the control signal to switch the bridge circuit on or off.

17. The correction method of claim 11, wherein the up-bridge circuit of the bridge circuit comprises an input port coupled to a second DC power supply, an output port, and a controlled port for connecting a voltage source received by the input port with the output port according to the control signal outputted from the control module; and the down-bridge circuit of the bridge circuit comprises an input port coupled to the output port of the up-bridge circuit, an output port coupled to the ground, and a controlled port for connecting a voltage source received by the input port with the output port according to the control signal outputted from the control module; wherein the motor is coupled between the output port of the up-bridge circuit and the output port of the down-bridge circuit.

18. The correction method of claim 11, wherein a switch is coupled between the first DC power supply and a capacitor to connect the first DC power supply with the electrostatic discharge diode.
